(19) United States
(12) Patent Application Publication
(10) Pub. No.: US 2010/0206675 A1
(43) Pub. Date: Aug. 19, 2010

(54) VENTILATED DISC ROTOR

(75) Inventors: Hiroyoshi Miyake, Kariya-shi (JP); Masatoshi Kano, Toyota-shi (JP); Hiroaki Nakanishi, Toyota-shi (JP); Masatoshi Watanabe, Toyota-shi (JP)

Correspondence Address: BUCHANAN, INGERSOLL & ROONEY PC, POST OFFICE BOX 1404, ALEXANDRIA, VA, 22313-1404, US

(73) Assignee: ADVICS CO., LTD., Kariya-city (JP)

(21) Appl. No.: 12/706,526

(22) Filed: Feb. 16, 2010

(30) Foreign Application Priority Data
Feb. 19, 2009 (JP) 2009-036208
Nov. 18, 2009 (JP) 2009-263297

(51) Int. Cl. F16D 65/12

(52) U.S. Cl. 188/218 XL

(57) ABSTRACT

A ventilated disc rotor includes a hat portion at which the ventilated disc rotor is attached to a rotation shaft, a sliding portion formed in an annular shape and provided at a radially outer portion of the hat portion, the ventilated disc rotor being slidably held by an inner pad and an outer pad at the sliding portion so as to brake a rotation of the ventilated disc rotor and the sliding portion including an inner disc-shaped portion, an outer disc-shaped portion and a plurality of cooling fins, wherein the hat portion and the plurality of cooling fins are integrally made of a steel plate material, and the outer disc-shaped portion and the inner disc-shaped portion are formed by casting together with the plurality of cooling fins in such a way that the plurality of cooling fins integrally connects the inner disc-shaped portion to the outer disc-shaped portion.

### CROSS REFERENCE TO RELATED APPLICATIONS

This application is based on and claims priority under 35 U.S.C. §119 to Japanese Patent Application 2009-036208, filed on Feb. 19, 2009 and Japanese Patent Application 2009-263297, filed on Nov. 18, 2009, the entire content of which is incorporated herein by reference.

### TECHNICAL FIELD

This disclosure relates to a ventilated disc rotor of a disc brake apparatus used, for example in a vehicle in order to brake a wheel of the vehicle.

### BACKGROUND DISCUSSION

A known ventilated disc rotor is formed with a hat portion (e.g., an attachment portion) at which the ventilated disc rotor is attached to a rotating shaft and formed with a sliding portion (e.g., a braking portion) being in an annular shape integrally with the hat portion so as to extend from a radially outer portion of the hat portion. The sliding portion is positioned between an inner pad and an outer pad so as to be slidably held thereby so that the ventilated disc rotor stops its rotation. Specifically, the sliding portion includes: an inner disc-shaped portion being slidable at a sliding surface thereof relative to the inner pad provided at a vehicle interior side; an outer disc-shaped portion being slidable at a sliding surface thereof relative to the outer pad provided at a vehicle exterior side; and plural cooling fins arranged between the inner disc-shaped portion and the outer disc-shaped portion so as to extend in a radial direction of the ventilated disc rotor, thereby connecting the inner disc-shaped portion to the outer disc-shaped portion.

A known ventilated disc rotor including a hat portion formed by a steel plate (e.g., one of metal plate materials) and a sliding portion formed by a casting iron (e.g., casting formed body) is disclosed, for example in JP2007-333039A.

According to the ventilated disc rotor disclosed in JP2007-333039A, because the hat portion is formed by pressing the steel plate, the weight of the ventilated disc rotor as a whole may be reduced compared to another disc rotor whose hat portion is formed by casting, however; the sliding portion of the ventilated disc rotor disclosed in JP2007-333039A is configured by an inner disc-shaped portion, an outer disc-shaped portion and a plurality of cooling fins, all of which are formed so as to be integrated together by casting, in such a way that the cooling fins are arranged between the inner disc-shaped portion and the outer disc-shaped portion so as to extend in a radial direction of the ventilated disc rotor. In this configuration, the disc rotor may not be further reduced in weight.

Further, according to the ventilated disc rotor disclosed in JP2007-333039A, the hat portion is connected to the sliding portion by means of connecting portions. Specifically, a plurality of connecting portions are fitted to a plurality of radially protruding portions of the hat portion, respectively, the radially protruding portion being integrally formed at an outer circumference of the hat portion so as to protrude outwardly in a radial direction of the hat portion. The hat portion to which the connecting portions are fitted at the radially protruding portion thereof is put in a casting mold, and melted iron is poured into the casting mold in order to form the sliding portion. In this configuration, because a length in a radial direction of the radially protruding portion and the connecting portion need to be set to some extent in order to connect (e.g., integrate) the hat portion to the sliding portion, this forming process may not be applied to a disc rotor whose diameter is relatively small.

### SUMMARY

According to an aspect of this disclosure, a ventilated disc rotor includes a hat portion at which the ventilated disc rotor is attached to a rotation shaft, a sliding portion formed in an annular shape and provided at a radially outer portion of the hat portion, the ventilated disc rotor being slidably held by an inner pad and an outer pad at the sliding portion so as to brake a rotation of the ventilated disc rotor; and the sliding portion including an inner disc-shaped portion, an outer disc-shaped portion and a plurality of cooling fins, the inner disc-shaped portion being slidably contactable at a sliding surface thereof to the inner pad, the outer disc-shaped portion being slidably contactable at a sliding surface thereof to the outer pad, and the plurality of cooling fins being arranged between the inner disc-shaped portion and the outer disc-shaped portion so as to extend in a radial direction of the ventilated disc rotor in order to connect the inner disc-shaped portion to the outer disc-shaped portion so as to be integral, wherein the hat portion and the plurality of cooling fins are integrally made of a steel plate material, and the outer disc-shaped portion and the inner disc-shaped portion are formed by casting together with the plurality of cooling fins in such a way that the plurality of cooling fins integrally connects the inner disc-shaped portion to the outer disc-shaped portion.

### BRIEF DESCRIPTION OF THE DRAWINGS

The foregoing and additional features and characteristics of this disclosure will become more apparent from the following detailed description considered with the reference to the accompanying drawings, wherein:

FIG. 1 illustrates a partially cross-sectional side view of a ventilated disc rotor of a first embodiment, in which cooling fins are processed by being twisted toward a vehicle interior side;

FIG. 2 is a cross section taken along a II-II line in FIG. 1;

FIG. 3 is an oblique perspective view schematically indicating a steel plate formed body of the ventilated disc rotor illustrated in FIGS. 1 and 2;

FIG. 4 is a partial cross section schematically indicating a modified embodiment in which each of the cooling fins illustrated in FIGS. 1 through 3 is formed so as to have a bending portion at one end portion of each of the cooling fins at the vehicle exterior side;

FIG. 5 is a partial oblique perspective view schematically indicating a modified embodiment in which each of the cooling fins illustrated in FIGS. 1 through 3 is formed so as to have a projecting formed portion at an intermediate position thereof in a radial direction of the ventilated disc rotor;

FIG. 6 is a partial oblique perspective view schematically indicating a modified embodiment in which each of the cooling fins illustrated in FIGS. 1 through 3 is formed so as to have a V-shaped portion at an intermediate position thereof in the radial direction of the ventilated disc rotor;

FIG. 7 is a partial oblique perspective view schematically indicating a modified embodiment in which each of the cooling fins illustrated in FIGS. 1 through 3 is formed so as to have a wave-shaped portion at an intermediate position thereof in the radial direction of the ventilated disc rotor;

FIG. 8 is a partial oblique perspective view schematically indicating a modified embodiment in which each of the cooling fins illustrated in FIGS. 1 through 3 is formed so as to curve in a rotational direction of the ventilated disc rotor;

FIG. 9 is an oblique perspective view of a steel plate formed body schematically indicating a modified embodiment in which each of the cooling fins illustrated in FIGS. 1 through 3 is formed with through holes opening in a thickness direction of the cooling fin;

FIG. 10 is a partial oblique perspective view schematically indicating a modified embodiment in which each of the cooling fins illustrated in FIGS. 1 through 3 is formed so as to have an air guiding portion at an intermediate position thereof in the radial direction of the ventilated disc rotor;

FIG. 11 is a partial cross section corresponding to FIG. 2 indicating a modified embodiment in which each of the cooling fins illustrated in FIGS. 1 through 3 is formed so as to have an axially projecting portion at the other end portion of each of the cooling fins in the axial direction of the ventilated disc rotor at a vehicle exterior side;

FIG. 12 is a partial oblique perspective view schematically indicating the steel plate formed body of the ventilated disc rotor in the modified embodiment illustrated in FIG. 11;

FIG. 13 is a partial oblique view schematically indicating a modified embodiment in which notches are formed at one end portion of the hat portion of the steel plate in FIGS. 1 through 3 where the cooling fins are formed;

FIG. 14 is an oblique view of a steel plate formed body in a modified embodiment in which each of the cooling fins in FIGS. 1 through 3 is formed by being twisted by a predetermined degree relative to the axis of the rotor;

FIG. 15 illustrates a partially cross-sectional side view of a ventilated disc rotor of a second embodiment, in which cooling fins are processed by being twisted toward a vehicle exterior side;

FIG. 16 is a cross section taken along a XVI-XVI line in FIG. 15;

FIG. 17 is an oblique perspective view of a steel plate formed body of a modified embodiment in which a holding portion formed in a annular shape is provided at an radially outer portion of the cooling fins so as to connect the cooling fins each other;

FIG. 18 is a partially enlarged oblique view of the steel plate formed body indicated in FIG. 17;

FIG. 19 is an oblique perspective view of a steel plate formed body of a modified embodiment in which a holding portion formed in an arc is provided at a radially outer portion of each of the cooling fins;

FIG. 20 is a partially enlarged oblique view of the steel plate formed body indicated in FIG. 19;

FIG. 21 is an oblique view of the steel plate formed body where the holding portion shown in each of FIGS. 17 and 18 is removed from a radially outer end portion of each of the cooling fins;

FIG. 22 is a partially enlarged oblique view of the steel plate formed body indicated in FIG. 21

FIG. 23 is a cross section corresponding to FIG. 2 indicating a modified embodiment in which the holding portion shown in FIG. 17 is not removed and is embedded within the outer casting formed body;

FIG. 24 is an oblique perspective view corresponding to FIG. 17 indicating a modified embodiment in which each of the cooling fins of the steel plate formed body is formed by a bending process;

FIG. 25 is a partially enlarged oblique view of the steel plate formed body indicated in FIG. 24;

FIG. 26 is an oblique perspective view corresponding to FIG. 19 indicating a modified embodiment in which each of the cooling fins of the steel plate formed body is formed by a bending process;

FIG. 27 is a partially enlarged oblique view of the steel plate formed body indicated in FIG. 26;

FIG. 28 is an oblique perspective view corresponding to FIG. 21 indicating a modified embodiment in which each of the cooling fins of the steel plate formed body is formed by a bending process;

FIG. 29 is a partially enlarged oblique view of the steel plate formed body indicated in FIG. 28;

FIG. 30 is a perspective view indicating a modified embodiment in which each of the cooling fins of the steel plate formed body shown in FIG. 24 is formed with a pair of through holes at the vehicle exterior side

FIG. 31 is a partially enlarged oblique view of the steel plate formed body indicated in FIG. 30;

FIG. 32 is an oblique view of the steel plate in formed body FIG. 30 where the holding portion shown in each of FIG. 30 is removed from the radially outer end portion of each of the cooling fins; and

FIG. 33 is a partially enlarged oblique view of the steel plate formed body indicated in FIG. 32.

### DETAILED DESCRIPTION

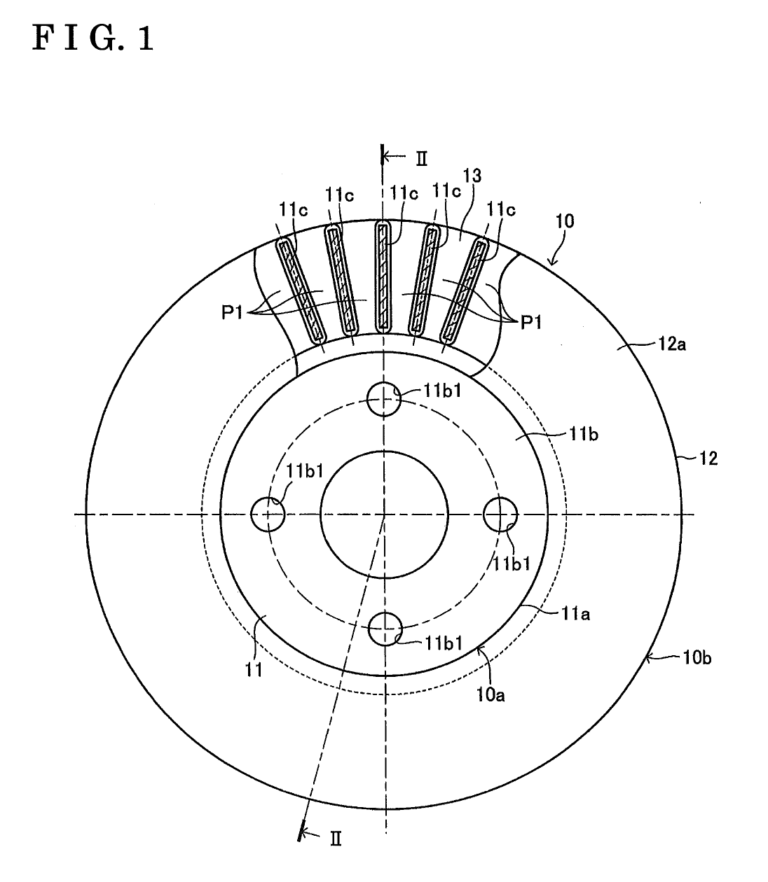

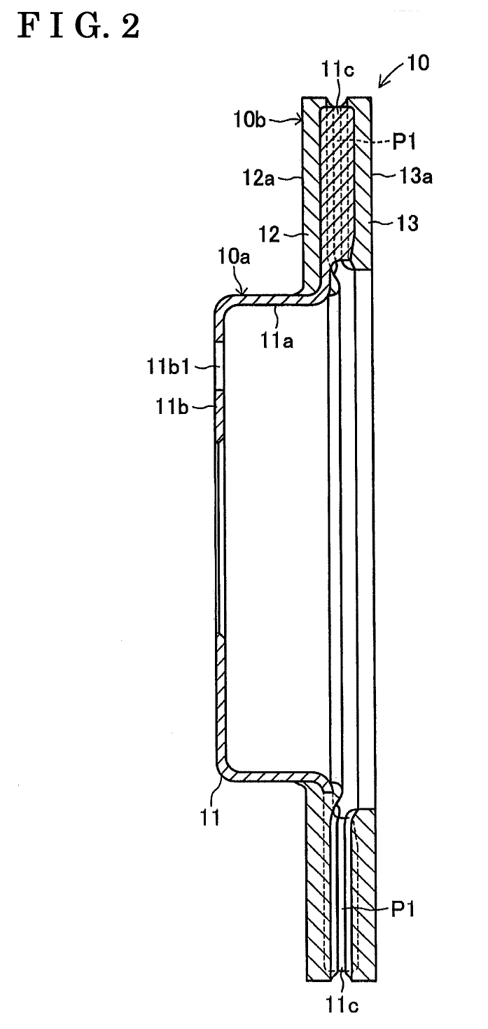

Embodiments of this disclosure will be explained in accordance with the attached drawings. Diagrams in FIGS. 1 through 3 indicate a first embodiment of a ventilated disc rotor (hereinafter referred to as a disc rotor or simply as a rotor). In the first embodiment, a disc rotor 10 is used at the disc brake apparatus applied to a vehicle in order to brake wheels of the vehicle. The disc rotor 10 is configured by a steel plate formed body 11 and casting formed bodies 12 and 13. The steel plate formed body 11 is formed by a process of pressing a sheet of steel plate so as to include a hat portion 10a and a sliding portion 10b. The hat portion 10a is formed in a cylindrical shape, and the sliding portion 10b is formed in an annular shape integrally with the hat portion 10a at an outer circumference of the hat portion 10a and at a right end of the hat portion 10a in FIG. 2. Each of the casting formed bodies 12 and 13 are formed in an annular shape by a process of casting and are arranged on each side of the steel plate formed body 11, respectively, so as to be in pair (right and left sides in FIG. 2) at the radially outer portion of the steel plate formed body 11.

The disc rotor 10 is attached to a rotation shaft (e.g., an axle) at the hat portion 10a in a known manner, and the hat portion 10a is configured by a cylindrical portion 11a and an annular flange portion 11b of the steel plate formed body 11. The annular flange portion 11b is formed so as to inwardly extend in a radial direction of the disc rotor 10 for a predetermined length from one end (e.g., a left end in FIG. 2) of the cylindrical portion 11a. In the first embodiment, four through holes 11b1 are formed at the annular flange portion 11b so as to be evenly distant from each other in a circumferential direction of the disc rotor 10. The disc rotor 10 is attached to the wheel by bolts inserted in the through holes 11b1, respectively.

The sliding portion 10b is slidably held between an inner pad and an outer pad so that the rotational speed of the disc rotor 10 is reduced, and eventually the rotation of the disc rotor 10 is stopped. The sliding portion 10b is configured by a plurality of cooling fins 11c of the steel plate formed body 11, the casting formed body 12 and the casting formed body 13. The casting formed body 12 is formed by a process of casting together with each of the cooling fins 11 c at a vehicle exterior side thereof (e.g., a left end portion of the cooling fin 11c in FIG. 2), and the casting formed body 13 is formed by a process of casting together with each of the cooling fins 11c at a vehicle interior side thereof (e.g., a right end portion of the cooling fin 11c in FIG. 2). In this configuration, at the sliding portion 10b, the casting formed body 12 is connected to the casting formed body 13 by means of cooling fins 11c so as to be integral.

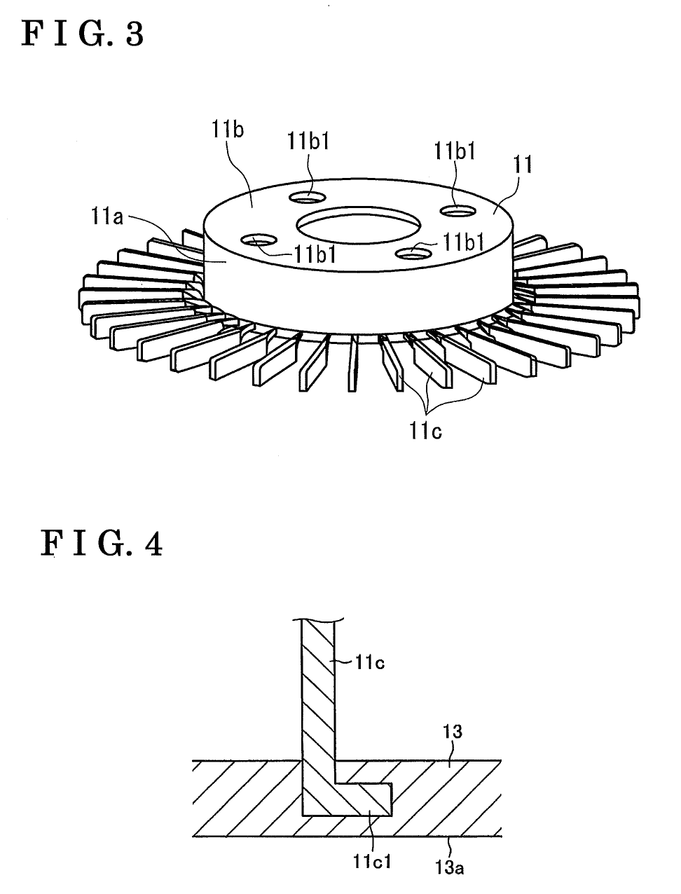

The steel plate formed body 11 is formed as follows. Firstly, a steel plate having a predetermined thickness is press-cut so as to be in a basic shape of the steel plate formed body 11 with fin portions, then a drawing process is applied to the press-cut plate in order to form the cylindrical portion 11a and the annular flange portion 11b, and finally each of the fin portions extending from the cylindrical portion 11a in the radial direction is processed by twisting to 90 degrees toward the vehicle interior side (e.g., rightward in FIG. 2) so as to be the cooling fin 11c indicated in the drawing of FIG. 3. The steel plate used in the process is one of metal made materials, and an aluminum base alloy plate or the like may be used. The four through holes 11b1 at the annular flange portion 11b are formed when the steel plate is press-cut to form the steel plate formed body 11. When the drawing process is applied to press-cut plate in order to form the cylindrical portion 11a and the annular flange portion 11b, the portion extending from the cylindrical portion 11a in the radial direction may not be cut in a fin shape (fin portions), and the fin shape may be formed by another press-cutting after the cylindrical portion 11a and the annular flange portion 11b are formed.

The casting formed body 12 functions as an outer disc-shaped portion where a left end sliding surface 12a of the casting formed body 12 slidably contacts to the outer pad. The casting formed body 12 is directly connected to an annular end portion of the hat portion 10a at a radially inner portion of the casting formed body 12, in other words the casting formed body 12 is directly connected to the cylindrical portion 11a of the steel plate formed body 11 at an outer circumferential surface of the right end portion of the cylindrical portion 11a in FIG. 2. The casting formed body 13 functions as an inner disc-shaped portion where a right end sliding surface 13a of the casting formed body 13 slidably contacts to the inner pad. A radially inner portion of the casting formed body 13 is distant from the annular end portion of the hat portion 10a at a predetermined length. In this configuration, a plurality of air passages P1 are formed between the cooling fins 11c, the casting formed body 12 and the casting formed body 13. The air may enter from the vicinity of an inner circumferential surface of the casting formed body 13 into each of the air passages P1.

According to the disc rotor 10 in the first embodiment, because the hat portion 10a is formed by pressing the steel plate (one of metal made plate materials), and the plurality of cooling fins 11c are also formed by cutting the steel plate, a thickness of the cooling fins 11c may be reduced comparing to a thickness of the cooling fins formed by casting, accordingly a weight of the disc rotor 10 may be reduced.

Further, the inner disc-shaped portion (casting formed body 13) and the outer disc-shaped portion (casting formed body 12) of the sliding portion 10b are formed by casting. Specifically, the inner disc-shaped portion (casting formed body 13) and the outer disc-shaped portion (casting formed body 12) are formed by the process of casting together with the cooling fins 11c formed integrally with the hat portion 10a (the cylindrical portion 11a and the annular flange portion 11b of the steel plate formed body 11) by press-cutting the steel plate. Accordingly, the inner disc-shaped portion (casting formed body 13) is integrally connected to the outer disc-shaped portion (casting formed body 12) by means of the cooling fins 11c. Thus, a connecting portion having a sufficient length in a radial direction between a radially outer end portion of the hat portion 10a at the vehicle interior side and a radially inner end portion of the sliding portion 10b may not be set in order to integrate the hat portion 10a to the sliding portion 10b, accordingly the weight of the disc rotor 10 may be reduced and the above described forming process may be applied to other disc rotors having a relatively small diameter.

Further, according to the disc rotor 10 in the first embodiment, the radially inner end portion of the casting formed body 12 (outer disc-shaped portion) is directly joined to the annular end portion of the hat portion 10a, in other words the radially inner end portion of the casting formed body 12 (outer disc-shaped portion) is connected to the outer circumferential surface of the cylindrical portion 11a at the right end portion in FIG. 2. Accordingly, an area of the joining surface at which the hat portion 10a is joined to the casting formed body 12 (outer disc-shaped portion, the sliding portion 10b) may be sufficiently secured. Thus, a connecting strength between the hat portion 10a and the sliding portion 10b may be increased.

In the first embodiment, each cooling fin 11c is formed in a flat plate shape, however, as illustrated in the drawing of FIG. 4, the cooling fins 11c may be formed so as to have a bending portion 11c1 bent in a rotational direction of the rotor at one end portion (e.g., a first side) of each of the cooling fins 11c so that the casting formed body 13 is formed by casting together with the cooling fins 11c at the bending portions 11c1. In this configuration, because the inner disc-shaped portion (casting formed body 13) is formed by casting together with the cooling fins 11c at the bending portion 11c1, a level of a joining strength between the cooling fins 11c and the inner disc-shaped portion may be increased compared to the first embodiment. The cooling fins 11c may further be formed so as to have another bending portion bending in the rotational direction of the rotor at the other end portion (e.g., a second side) of each of the cooling fins 11c so that the casting formed body 12 is formed by casting with the cooling fins 11c at the bending portions. In this configuration, because the outer disc-shaped portion (casting formed body 12) is formed by casting together with the cooling fins 11c at the bending portion, a level of a joining strength between the cooling fins 11c and the outer disc-shaped portion may be increased compared to the first embodiment.

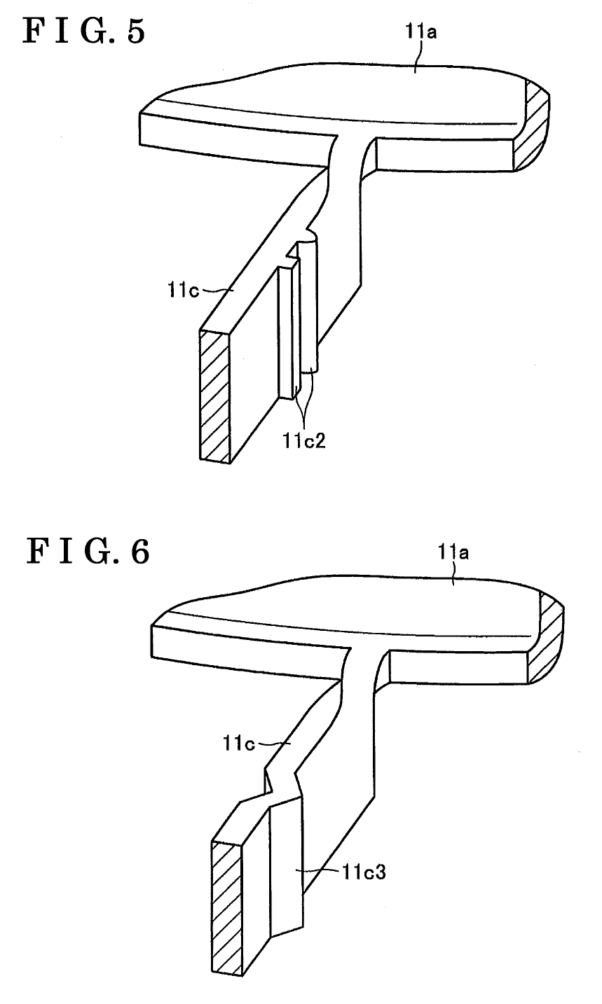

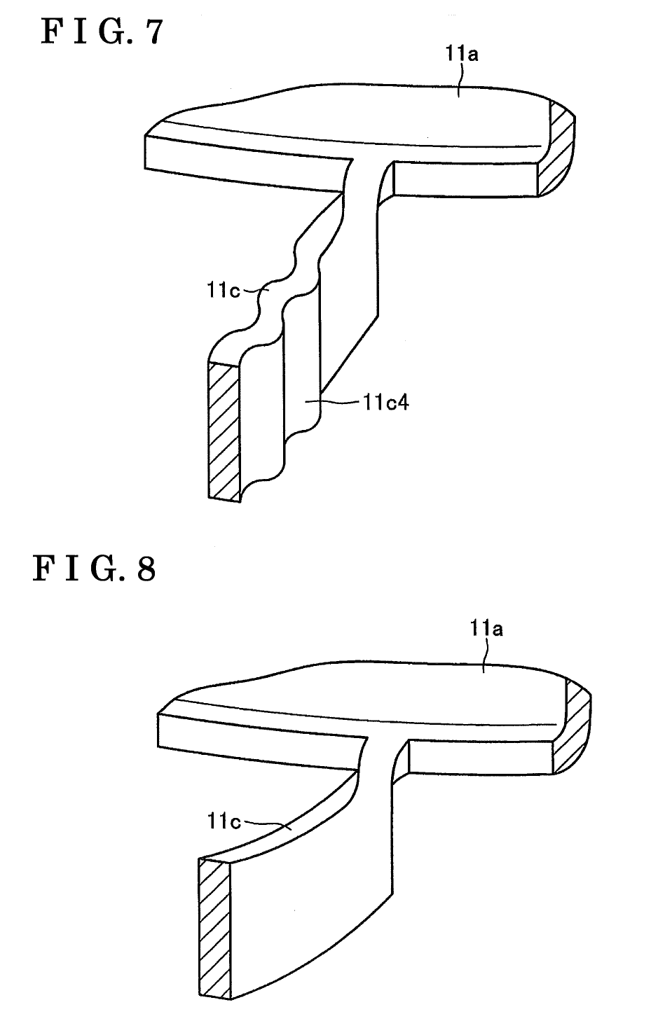

Further, although each of the cooling fins 11c is formed in the flat plate shape in the first embodiment, each of the cooling fins 11c may be formed with a formed portion by which each of the cooling fins 11c may be restrained from being bending-deformed in a rotational direction of the rotor or an axial direction of the rotor. The formed portion may be formed in a projecting shape as illustrated in FIG. 5, formed in a V-shape as illustrated in FIG. 6 or formed in a wave shape as illustrated in FIG. 7. The formed portion illustrated in FIG. 5 is referred to as projecting formed portions 11c2, the formed portion illustrated in FIG. 6 is referred to as a V-shaped portion 11c3 and the formed portion illustrated in FIG. 7 is referred to as a wave-shaped portion 11c4. Each of the cooling fins 11c may be formed so as to curve within an entire length thereof in a radial direction of the rotor as illustrated in the drawing of FIG. 8 so that each of the cooling fins 11c may be restrained from being bending-deformed in the rotational direction of the rotor or an axial direction of the rotor. In those cases, even when the steel plate used to form the cooling fins 11c is relatively thin, a rigidity of each of the cooling fins 11c may be sufficiently secured to a level at which the cooling fins 11c may be restrained from being bending-deformed in the rotational direction of the rotor or the axial direction of the rotor, thereby reducing the weight of the disc rotor. Each of the projecting formed portions 11c2, the V-shaped portion 11c3 and the wave-shaped portion 11c4 is formed at a intermediate position of each of the cooling fins 11c in the radial direction of the rotor along the axial direction of the rotor.

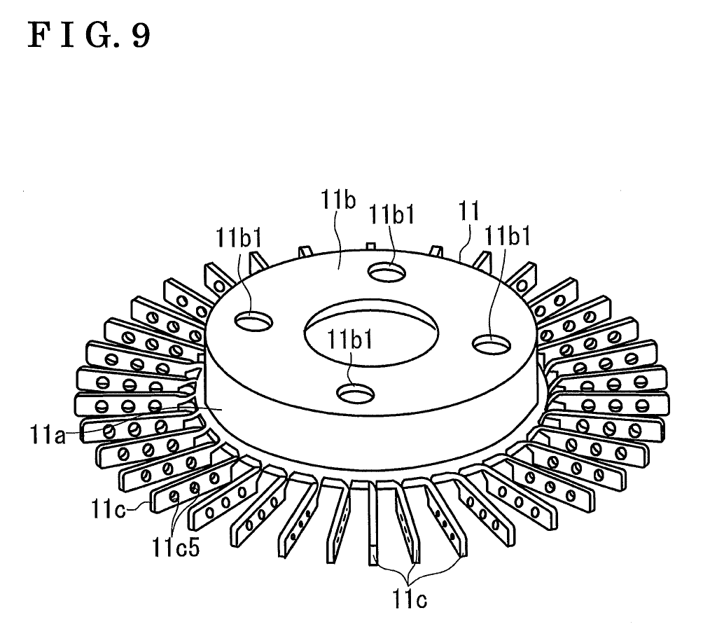

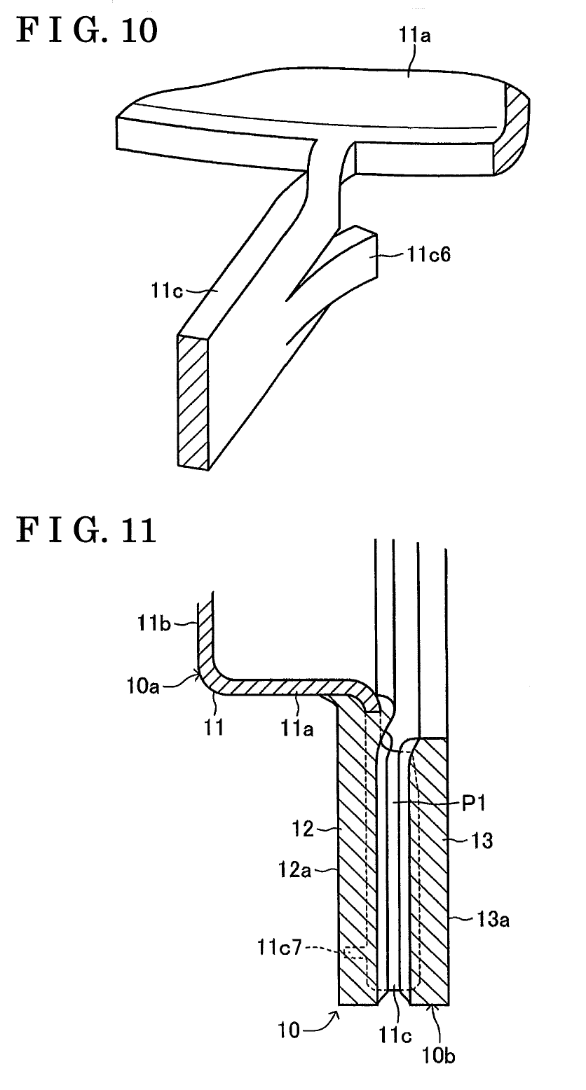

According to the first embodiment, each of the cooling fins 11c may be formed with at least one of through holes 11c5 opening in a thickness direction of the cooling fin 11c as illustrated in the diagram of FIG. 9. In this configuration, a surface area of the cooling fin 11c may be increased by existence of the through hole(s) 11c5, and further a level of a cooling performance at the cooling fins 11c may be increased because of the through hole(s) 11c5. Furthermore, because of the through hole(s) 11c5, the weight of the disc rotor may be reduced.

According to the first embodiment, an air guiding portion 11c6 may be formed at each of the cooling fins 11c by which air is guided to the air passage P1 (indicated in the drawings of FIGS. 1 and 2) defined between the cooling fins 11c, the inner disc-shaped portion (casting formed body 13) and the outer disc-shaped portion (casting formed body 12). The air guiding portions 11c6 are formed on the cooling fins 11c, respectively, at the radially inner portion thereof in the radial direction of the disc rotor. In this configuration, when the disc rotor is rotated, air may be actively guided to the air passages P1 by means of the air guiding portions 11c6, accordingly a level of the cooling performance at the cooling fins 11c may further be increased.

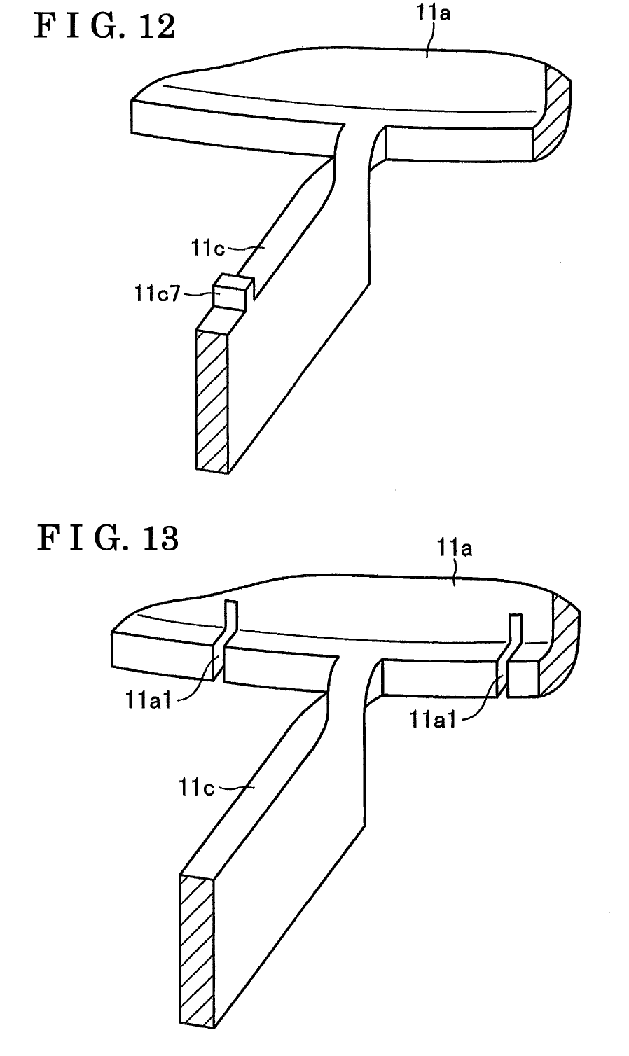

According to the first embodiment, each of the cooling fins 11c may be formed with an axially projecting portion 11c7 at one end portion (e.g., the second side facing the vehicle exterior side) of the cooling fin 11c in the axial direction of the rotor as illustrated in FIGS. 11 and 12. The axially projecting portion 11c7 is formed so as to extend toward the sliding surface 12a of the outer disc-shaped portion (casting formed body 12) in a predetermined length. In this configuration, the length of the axially projecting portion 11c7 may be set so as to correspond to an abrasion limit of the sliding portion 10b. In other words, the length of the axially projecting portion 11c7 may be set in a manner where an end portion thereof may appear exceeding the sliding surface 12a when the sliding portion 10b is worn so as to reach the abrasion limit. Accordingly, a user (e.g., a driver) may recognize the abrasion limit of the sliding portion 10b based on a visual confirmation and/or an abnormal noise (e.g., noise change) of the pads sliding on the sliding portion. In other words, the axially projecting portion 11c7 may function as an indicator for indicating the abrasion limit of the sliding portion 10b. Each of the cooling fins 11c may alternatively be formed with an axially projecting portion at the other end portion (e.g., the first side facing the vehicle interior side) of the cooling fin 11c in the axial direction of the rotor, instead of the axially projecting portion 11c7 formed on the second side. The axially projecting portion at the other end surface of the cooling fin 11c is formed so as to extend toward the sliding surface 13a of the inner disc-shaped portion (casting formed body 13) in a predetermined length. In those cases, the axially projecting portions may not be formed on all of the cooling fins 11c, and may be formed on selected cooling fins 11c. At least one of the cooling fins 11c may be formed with the axially projecting portion.

Furthermore, according to the first embodiment, the hat portion may be formed with plural notches 11a1 at one end portion where the cooling fins 11c are formed. In other words, the steel plate formed body 11 may be formed with the notches 11a1 at one end portion of the cylindrical portion 11a where the cooling fins 11c are formed. Each of the notches 11a1 is formed so as to extend in the axial direction of the rotor for a predetermined length at a position between two adjacent cooling fins 11c. In this configuration, the deformation of the hat portion 10a, which may occur when the disc rotor is heated so as to be thermally expanded due to frictional heat upon the braking operation, may be compensated by the notches 11a1, as a result, vibrations on the braking operation (e.g., brake noise) due to the deformation of the hat portion 10a may be reduced.

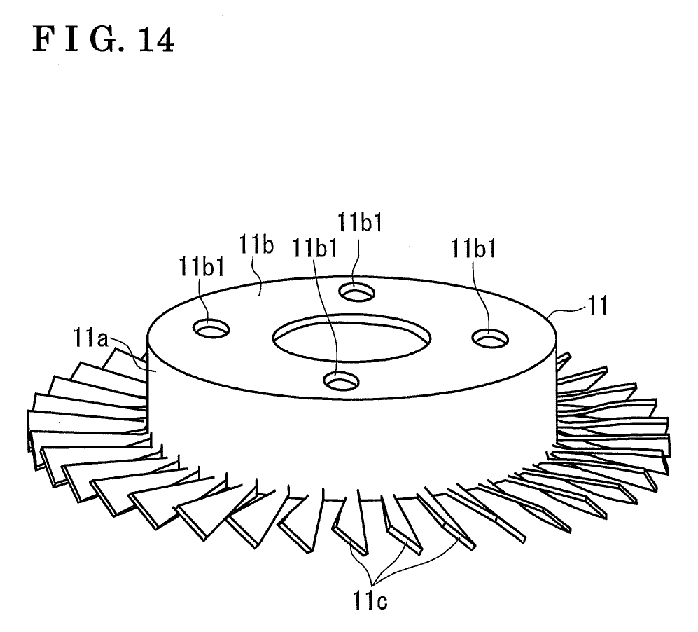

Further, according to the first embodiment, each of the cooling fins 11c is processed by being twisted by 90 degrees at a connecting portion to the cylindrical portion 11a so that the cooling fin 11c is arranged so as to extend in the axial direction of the rotor. However, as illustrated in the drawing of FIG. 14, the cooling fins 11c may be processed by being twisted by 45 degrees at the connecting portion to the cylindrical portion 11a so that the cooling fin 11c is arranged so as to extend having an angle of 45 degrees relative to the axial direction of the rotor. In this configuration, an amount of the process for twisting the cooling fins 11c relative to the cylindrical portion 11a may be reduced compared to the first embodiment.

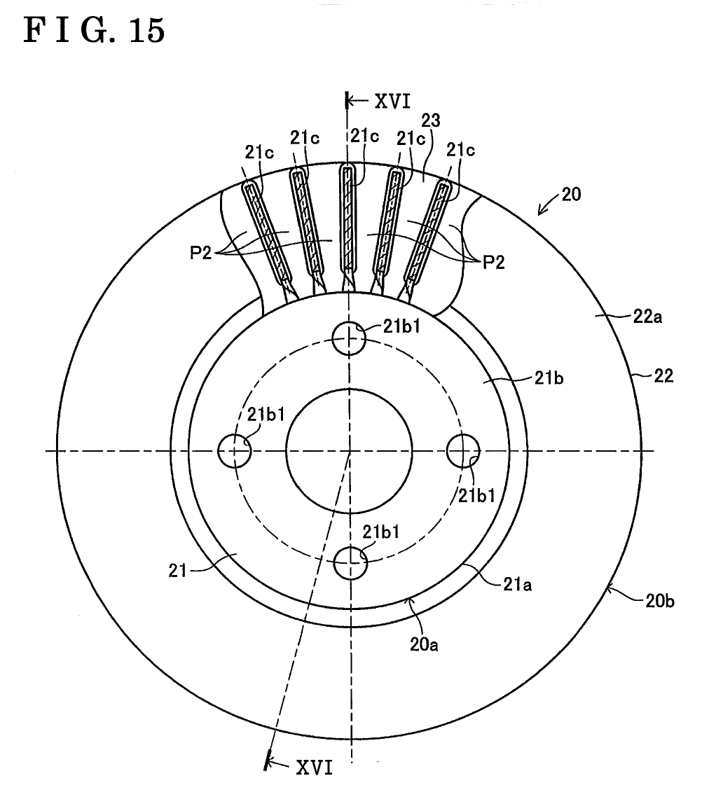

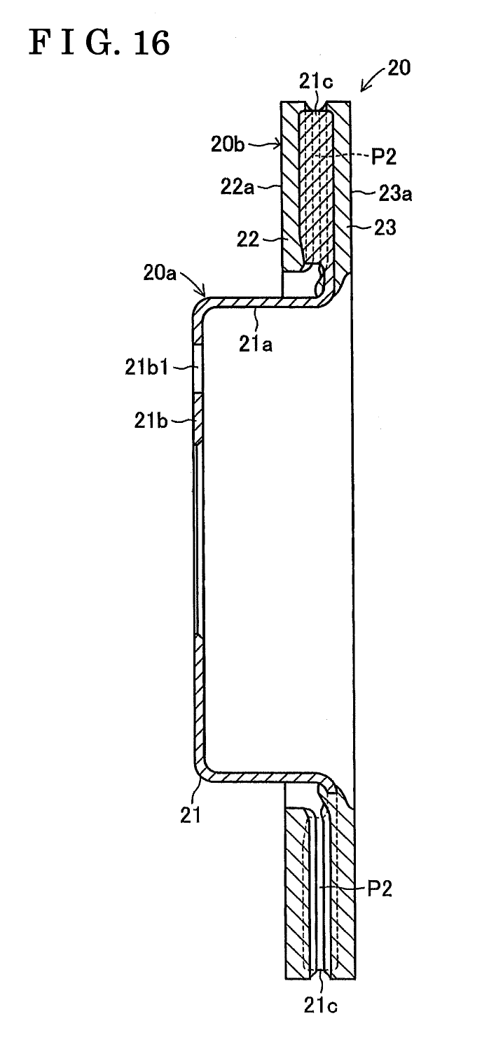

A second embodiment of this disclosure will be explained in accordance with the attached drawings. According to the first embodiment, the disc rotor 10 is formed with the approximately cylindrical shaped hat portion 10a and the approximately annular shaped sliding portion 10b and including the steel plate formed body 11 and a pair of the casting formed bodies 12 and 13. According to the second embodiment, as illustrated by the drawings of FIGS. 15 and 16, a disc rotor 20 is formed with an approximately cylindrical shaped hat portion 20a and an approximately annular shaped sliding portion 20b and including a steel plate formed body 21 and a pair of casting formed bodies 22 and 23.

The disc rotor 20 in the second embodiment is illustrated in FIGS. 15 and 16. The disc rotor 20 is formed with cooling fins 21c that are twisted by 90 degrees in the opposite direction (toward the vehicle exterior side) of the twisted direction of the cooling fins 11c of the steel plate formed body 11 in the first embodiment. A radially inner portion of the casting formed body 22 is provided so as to be distant at a predetermined length from an annular end portion (e.g., an right end in FIG. 16) of the hat portion 20a. On the other hand, a radially inner portion of the casting formed body 23 is directly joined to the annular end portion (e.g., the right end in FIG. 16) of the hat portion 20a, in other words a radially inner portion of the casting formed body 23 is directly joined to a radially outer and right end portion of the cylindrical portion 21a of the steel plate formed body 21. In this configuration, a plurality of air passages P2 is formed by means of the cooling fins 21c between the casting formed body 22 and the casting formed body 23. The air passing along an inner peripheral surface of the casting formed body 22 may enter the air passages P2. Other configurations and components of the disc rotor 20 are identical to those of the disc rotor 10 in the first embodiment therefore explanations of the identical components will be omitted. The identical components will be referred to by using numerals obtained by adding a decimal to the numerals in the first embodiment. Results of the adaptation of the disc rotor 20 are practically identical to that of the disc rotor 10 in the first embodiment.

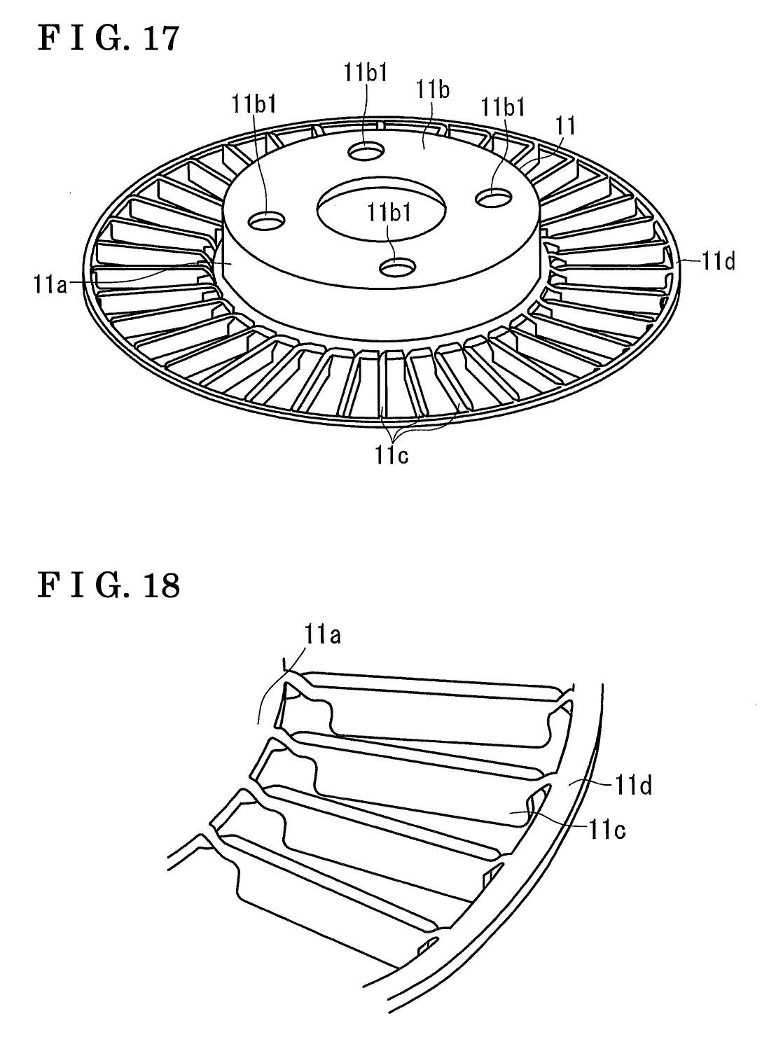

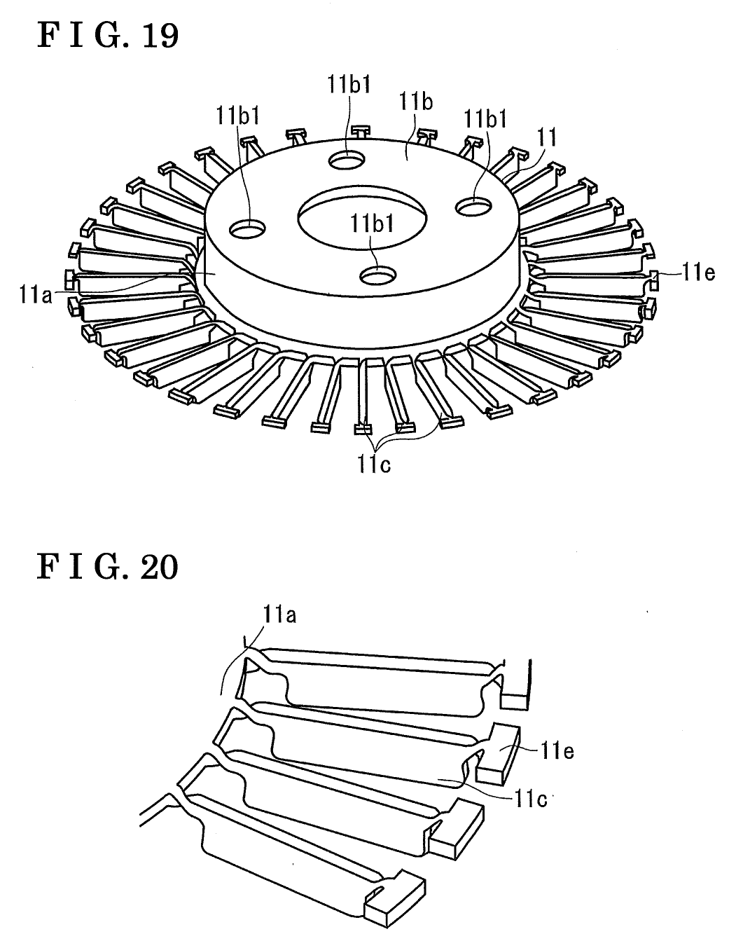

In the example illustrated in FIGS. 15 and 16, each of the cooling fins 21c of the steel plate formed body is processed by twisting in a manner where the radially outer end portion of the cooling fin 21c is not fixed, however, the cooling fins 21c may be formed as indicated by an example in the drawings of FIGS. 17 and 18 and an example in the drawings of FIGS. 19 and 20.

According to the example of FIGS. 17 and 18, a holding portion 11d is formed in an annular shape at a radially outer end portion of the disc rotor 20 so as to connect the cooling fins 11c to each other. The annular shaped holding portion 11d is formed in a circular shape setting its center to a rotational center of the disc rotor 10 and connecting the cooling fins 11c in a continuous manner. Further, when each of the cooling fins 11c is processed by twisting, the disc rotor 10 is held by a clamp device at the holding portion 11d. Accordingly, the cooling fins 11c may not be unnecessarily deformably-displaced, each of the cooling fins 11c is processed with high accuracy.

In the example illustrated in FIGS. 19 and 20, a holding portion 11e is formed in an arc shape at a radially outer end portion of each of the cooling fins 11c. The holding portion 11e is formed in an arc shape relative to a rotational center of the disc rotor 20, and when each of the cooling fins 11c is processed by twisting, the disc rotor 20 is held by the clamp device. Accordingly, each of the cooling fins 11c is also processed with high accuracy.

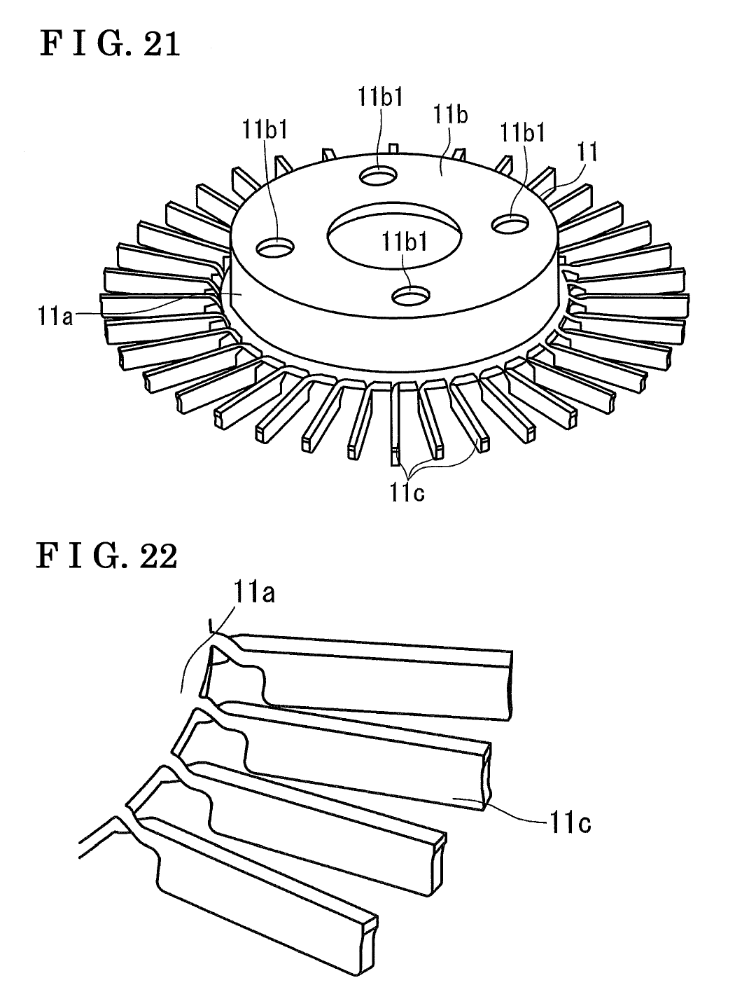

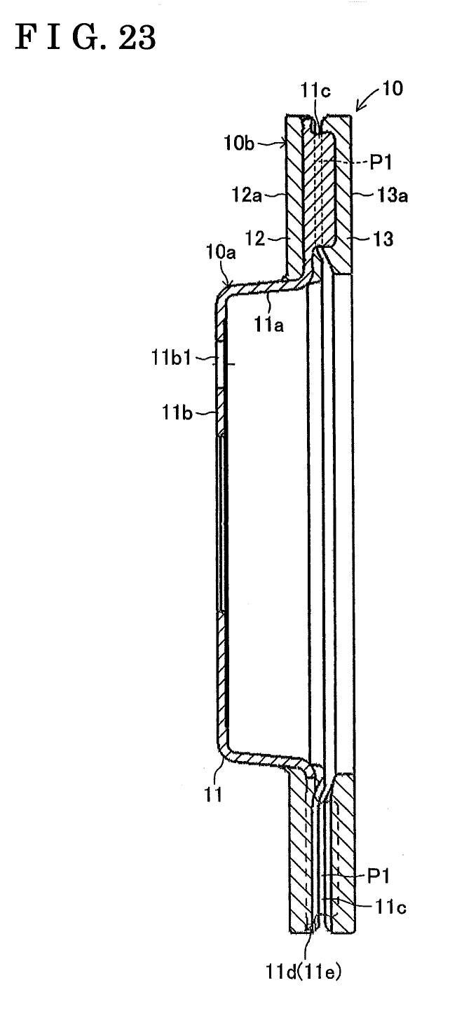

According to the example in FIGS. 17 and 18 and the example in FIGS. 19 and 20, the annular shaped holding portion 11d and the arc shaped holding portion 11e may be cut (e.g., removed) from the radially outer end portion of each of the cooling fins 11c so as to be the shape illustrated in the drawings of FIGS. 21 and 22. Then the pair of the casting formed bodies 12 and 13 are formed by casting with the cooling fins 11c. Alternatively, the annular shaped holding portion 11d and the arc shaped holding portion 11e may not be removed from the radially end portion of each of the cooling fins 11c, and the pair of the casting formed bodies 12 and 13 may be formed by casting together with the holding portions 11d or the holding portion 11e, in other words the holding portion 11d or the holding portion 11e may be embedded within the outer casting formed body as indicated in the drawing of FIG. 23.

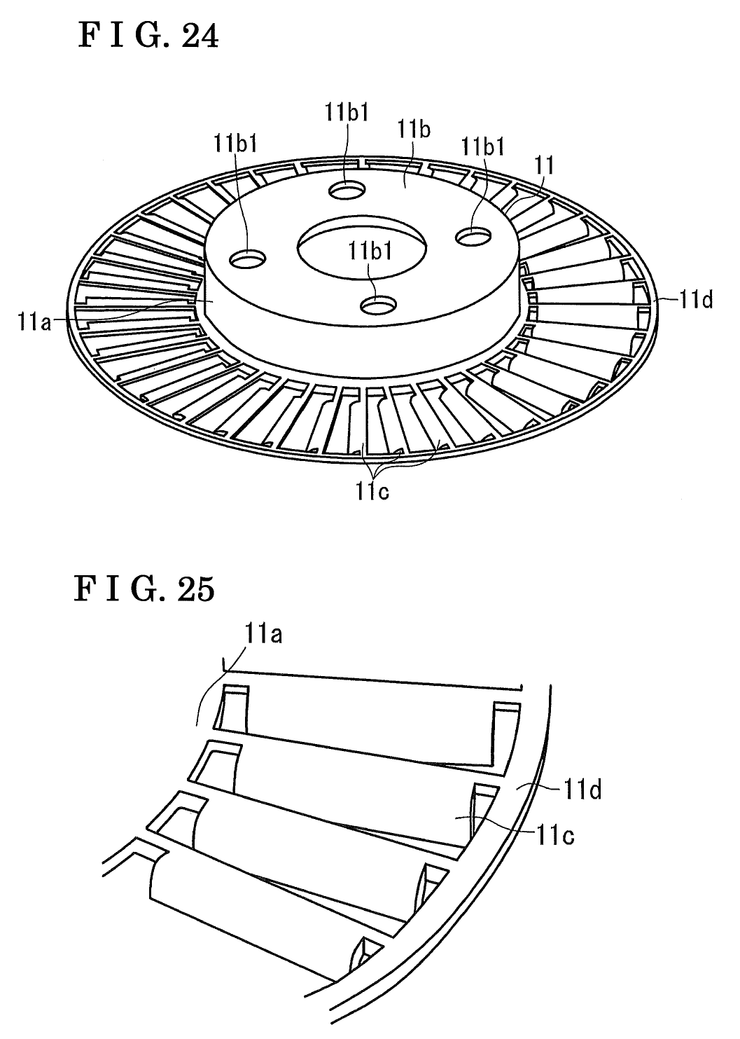

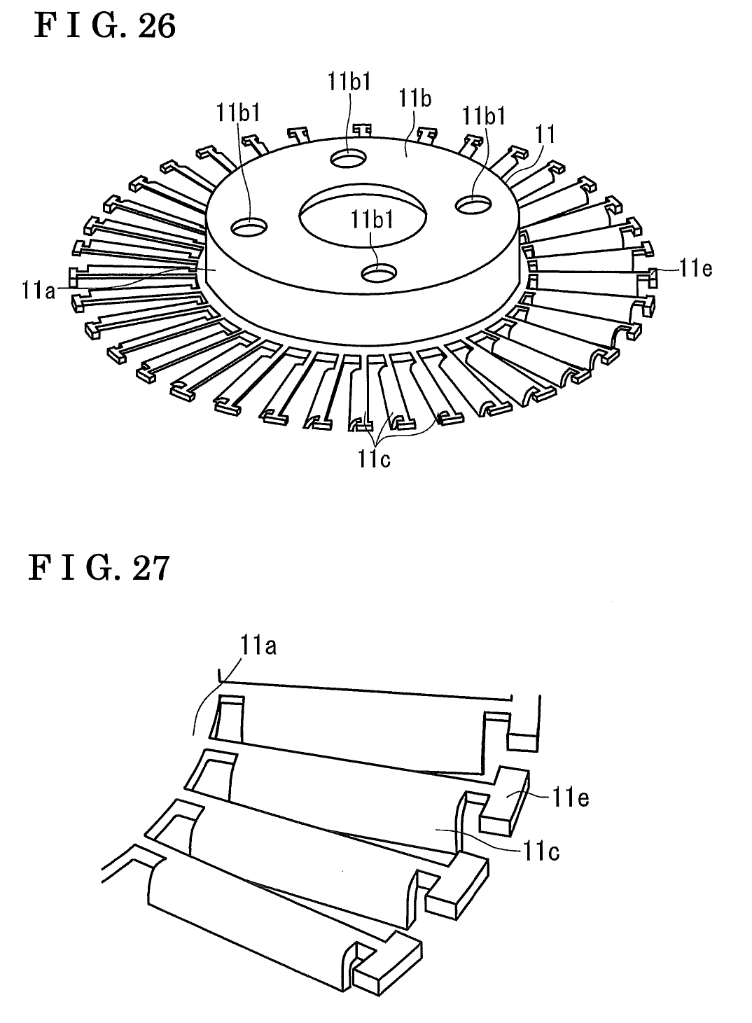

In the embodiment, each of the cooling fins 11c of the steel plate formed body is processed by twisting. However, each of the cooling fins 11c of the steel plate formed body 11 may be formed by a bending process as illustrated in an example of FIGS. 24 and 25 and an example of FIGS. 26 and 27. When each of the cooling fins 11c is formed by the bending process, because the connecting portion between the cylindrical portion 11a (hat portion) and each of the cooling fins 11c may not be deformed so as to be twisted, a strength of the connecting portion may be increased compared by the cooling fins 11c formed by the twisting process. When each of the cooling fins 11c is formed by the bending process, a flat portion extending from a connecting portion between the hat portion 11a and each of the cooling fins 11c, to which the bending process is not applied, may be set as a holding portion, and the bending process is applied to the cooling fins 11c in a manner where each of the cooling fins 11c is held by the clamp device at the connecting portion. In this configuration, when a portion being orthogonal to the axis of the rotor after the bending process is applied to the cooling fins 11c in order to increase the number of the cooling fins 11c, an area of the holding portion extending from the connecting portion between the hat portion 11a and each of the cooling fins 11c may be reduced, consequently each of the cooling fins 11c may not be sufficiently fixed by the clamp device when the bending process is applied to each of the cooling fins 11c. Accordingly, in the same manner as described in the examples of FIGS. 17 through 20, even when the cooling fins 11c are formed by the bending process, a holding portion may be provided at a radially outer end portion of each of the cooling fins 11c, and when the bending process is applied to the cooling fins 11c, the clamp device may surely hold the cooling fins 11c at the holding portion arranged at the radially outer end portion of the cooling fins 11c. In the example illustrated in FIGS. 24 and 25, a holding portion 11d is formed in an annular shape at a radially outer end portion of the disc rotor 20 so as to connect the cooling fins 11c to each other. In the example illustrated in FIGS. 26 and 27, a holding portion 11e is formed in an arc shape at a radially outer end portion of each of the cooling fins 11c. In this configuration, each of the cooling fins 11c is processed with high accuracy.

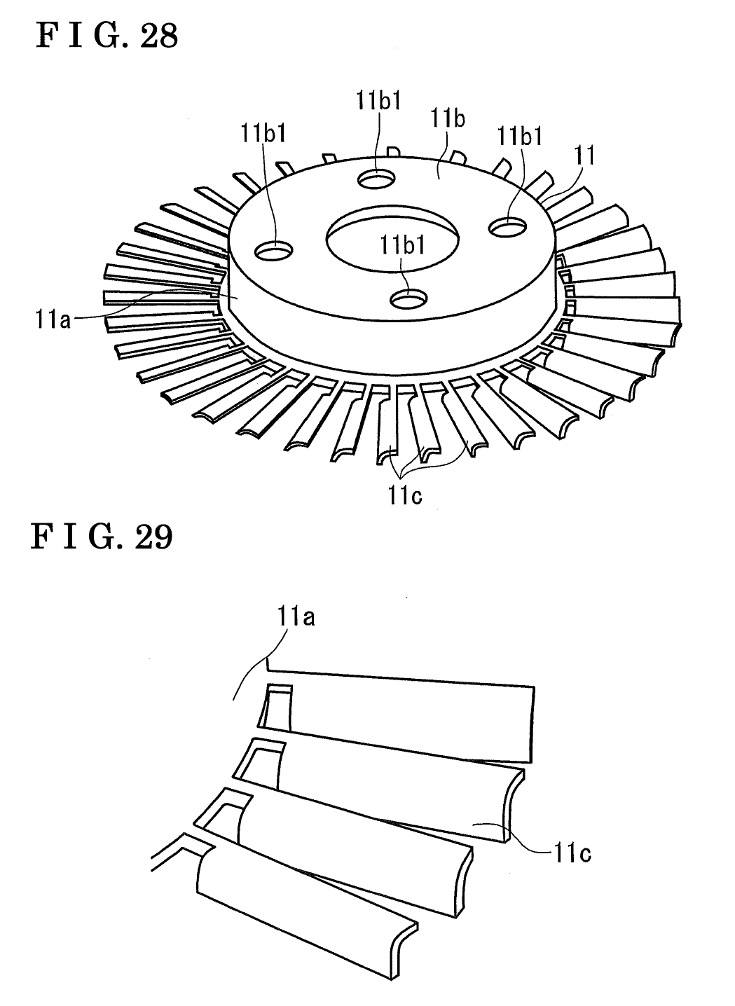

According to the example in FIGS. 24 and 25 and the example in FIGS. 26 and 27, the annular shaped holding portion 11d and the arc shaped holding portion 11e may be cut (e.g., removed) from the radially end portion of each of the cooling fins 11c so as to be the shape illustrated in the drawings of FIGS. 28 and 29. Then the pair of the casting formed bodies 12 and 13 are formed by casting with the cooling fins 11c. Alternatively, the annular shaped holding portion 11d and the arc shaped holding portion 11e may not be removed from the radially outer end portion of each of the cooling fins 11c, and the pair of the casting formed bodies 12 and 13 may be formed by casting together with the holding portions 11d or the holding portion 11e, in other words the holding portion 11d or the holding portion 11e may be embedded within the outer casting formed body as indicated in the drawing of FIG. 23. When the steel plate formed body 11 is formed as illustrated in FIGS. 28 and 29, instead of the holding portion 11e described above, a holding portion is set at a radially outer end portion of each of the cooling fins 11c at the vehicle outer side.

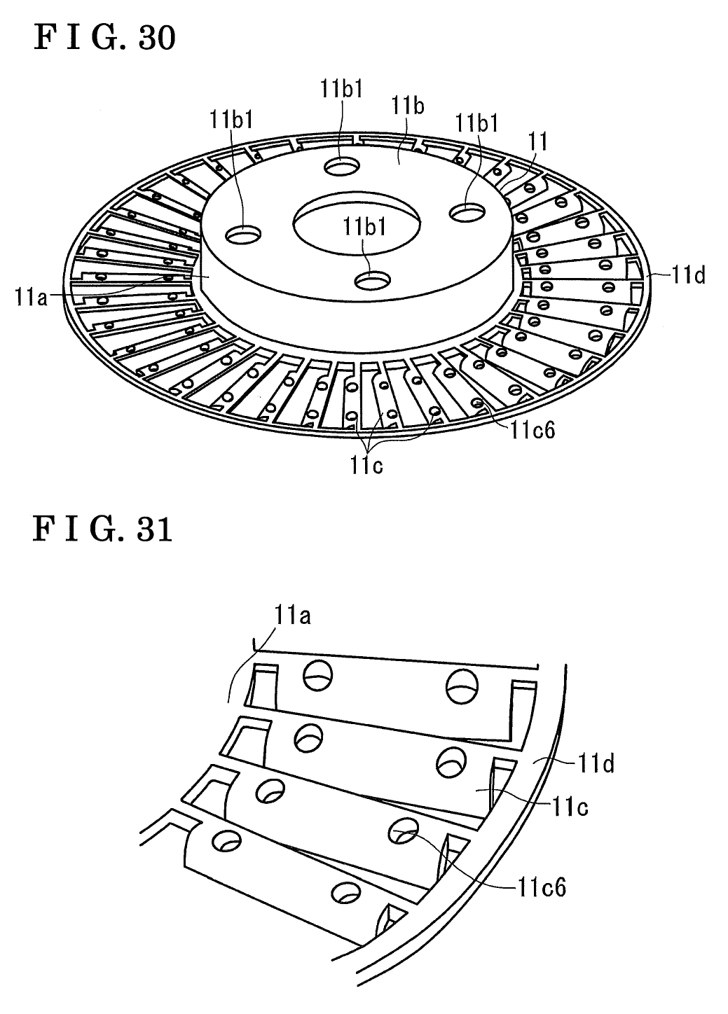

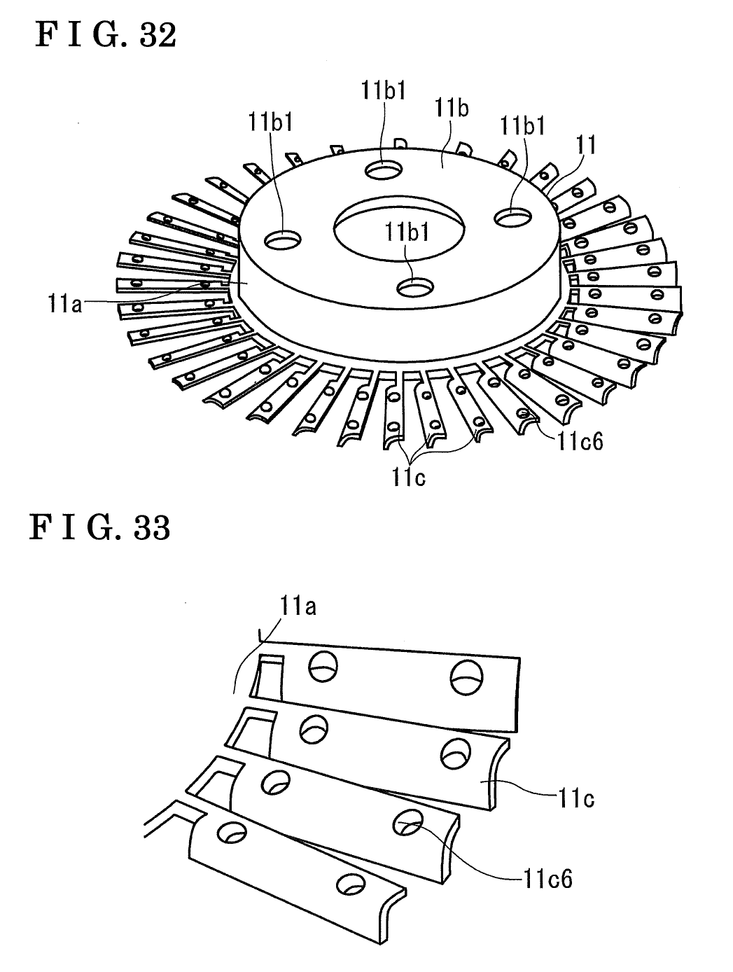

In the example illustrated in FIGS. 24 and 25, a pair of through holes 11c6 may be formed at each of the cooling fins 11c at the vehicle exterior side together therewith the outer casting formed body 12 is formed by casting as illustrated in FIGS. 30 and 31. The through hole 11c6 may be formed in an elongated shape. Because of the pair of the through holes 11c6, melted iron or the like may preferably flow so that possibilities where porosities or the like are formed in the outer casting formed bodies may be reduced, as a result, a strength of a connection between each of the cooling fins 11c and both of the outer casting formed bodies 12 and 13 may be increased. According to the example in FIGS. 30 and 31, the annular shaped holding portion 11d and the arc shaped holding portion 11e may not be removed from the radially outer end portion of each of the cooling fins 11c, and then the pair of the casting formed bodies 12 and 13 are formed by casting with the cooling fins 11c in a manner where the holding portion 11d is embedded within the outer casting formed body 12. According to the example in FIGS. 30 and 31, the annular shaped holding portion 11d may be cut (e.g., removed) from the radially outer end portion of each of the cooling fins 11c so as to be the shape illustrated in the drawings of FIGS. 32 and 33. Then the pair of the casting formed bodies 12 and 13 is formed by casting with the cooling fins 11c.

The modified embodiments shown in FIGS. 17 through 33 are explained in such a way that the holding portions (11d and/or 11e) are formed at each of the cooling fins 11c of the steel plate formed body 11 in the first embodiment indicated in FIGS. 1 through 3, however, the holding portions (11d and/or 11e) may be formed at each of the cooling fins 21c of the steel plate formed body 21 in the second embodiment indicated in FIGS. 15 and 16.

According to the embodiments, because the hat portion is formed by pressing the steel plate (one of metal made plate materials), and the plurality of cooling fins are also formed by cutting the steel plate, a thickness of the cooling fins may be reduced comparing to a thickness of the cooling fins formed by casting, accordingly a weight of the disc rotor may be reduced.

Further, the inner disc-shaped portion and the outer disc-shaped portion of the sliding portion are formed by casting. Specifically, the inner disc-shaped portion and the outer disc-shaped portion are formed by the process of casting together with the cooling fins formed integrally with the hat portion by press-cutting the steel plate. Accordingly, the inner disc-shaped portion is integrally connected to the outer disc-shaped portion by means of the cooling fins. Thus, a connecting portion having a sufficient length in a radial direction between a radially outer end portion of the hat portion at the vehicle interior side and a radially inner end portion of the sliding portion may not be set in order to integrate the hat portion to the sliding portion, accordingly the weight of the disc rotor may be reduced and the above described forming process may be applied to other disc rotors having a relatively small diameter.

According to another aspect of this disclosure, each of the cooling fins is formed with a holding portion formed in an annular shape and circularly setting its center to a rotational center of the ventilated disc rotor, at a radially outer end portion of the cooling fins so as to connect the cooling fins to each other in a continuous manner, and the cooling fins are held at the holding portion when each of the cooling fins is processed by twisting or bending, or each of the cooling fins is formed with a holding portion formed in an arc shape relative to a rotational center of the ventilated disc rotor, at a radially outer end portion of the each of the cooling fins, and the cooling fins are held at the holding portion when each of the cooling fins is processed by twisting or bending.

Further, the holding portion is removed from the radially outer end portion of the each of the cooling fins by cutting therefrom after the each of the cooling fins is processed by twisting or bending. Furthermore, the outer disc-shaped portion is formed by casting together with a portion of the cooling fins at which the holding portion is formed.

Thus, the holding portion is formed as mentioned above may be used when each of the cooling fins is processed by twisting or bending, the disc rotor is held by the clamp device. Accordingly, each of the cooling fins is also processed with high accuracy.

According to another aspect of this disclosure, a radially inner portion of at least one of the inner disc-shaped portion and the outer disc-shaped portion is directly joined to an annular end portion of the hat portion. Thus, an area of the joining surface at which the hat portion is joined to the sliding portion may be sufficiently secured, and a connecting strength between the hat portion and the sliding portion may be increased. Further, according to another aspect of this disclosure, a bending portion is formed at at least one of first and second sides of the each of the cooling fins so as to bend in a rotational direction of the ventilated disc rotor, the inner disc-shaped portion is formed by casting together with the each of the cooling fins at the first surface thereof, and the outer disc-shaped portion is formed by casting together with the each of the cooling fins at the second surface thereof. Thus, a level of a joining strength between the cooling fins and the outer disc-shaped portion and/or the cooling fins and the inner disc-shaped portion may be increased compared to the first embodiment.

According to another aspect of this disclosure, each of the cooling fins is formed with a formed portion by which the each of the cooling fins is restrained from being bending-deformed in the rotational direction of the ventilated disc rotor or an axial direction of the ventilated disc rotor. Thus, even when the steel plate used to form the cooling fins is relatively thin, a rigidity of each of the cooling fins may be sufficiently secured to a level at which the cooling fins may be restrained from being bending-deformed in the rotational direction of the rotor or the axial direction of the rotor, thereby reducing the weight of the disc rotor.

According to another aspect of this disclosure, each of the cooling fins is formed with at least one of through holes opening in a thickness direction of the each of the cooling fins. In this configuration, a surface area of the cooling fin may be increased by existence of the through hole(s), and further a level of a cooling performance at the cooling fins may be increased because of the through hole(s). Furthermore, because of the through hole(s), the weight of the disc rotor may be reduced.

According to another aspect of this disclosure, each of the cooling fins is formed with an air guiding portion at the radially inner portion of the cooling fins in the radial direction of the ventilated disc rotor for guiding air to an air passage that is defined by each of the cooling fins, the inner disc-shaped portion, and the outer disc-shaped portion. In this configuration, when the disc rotor is rotated, air may be actively guided to the air passages by means of the air guiding portions, accordingly a level of the cooling performance at the cooling fins may further be increased.

According to another aspect of this disclosure, each of the cooling fins is formed with an axially projecting portion at one end surface of the cooling fin in the axial direction of the ventilated disc rotor so as to extend toward at least one of the sliding surface of the outer disc-shaped portion and the sliding surface of the inner disc-shaped portion in a predetermined length. In this configuration, the length of the axially projecting portion may be set so as to correspond to an abrasion limit of the sliding portion. In other words, the length of the axially projecting portion may be set in a manner where an end portion thereof may appear exceeding the sliding surface when the sliding portion is worn so as to reach the abrasion limit. Accordingly, a user (e.g., a driver) may recognize the abrasion limit of the sliding portion based on a visual confirmation and/or an abnormal noise (e.g., noise change) of the pads sliding on the sliding portion (used as an indicator).

According to another aspect of this disclosure, the hat portion is formed with plural notches at one end portion thereof where the cooling fins are formed so as to extend in the axial direction of the ventilated disc rotor for a predetermined length at a position between two adjacent cooling fins. In this configuration, the deformation of the hat portion, which may occur when the disc rotor is heated so as to be thermally expanded due to frictional heat upon the braking operation, may be compensated by the notches, as a result, vibrations on the braking operation (e.g., brake noise) due to the deformation of the hat portion may be reduced.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A ventilated disc rotor comprised of:
a hat portion at which the ventilated disc rotor is attached to a rotation shaft;
a sliding portion formed in an annular shape and provided at a radially outer portion of the hat portion, the ventilated disc rotor being slidably held by an inner pad and an outer pad at the sliding portion so as to brake a rotation of the ventilated disc rotor; and
the sliding portion including an inner disc-shaped portion, an outer disc-shaped portion and a plurality of cooling fins, the inner disc-shaped portion being slidably contactable at a sliding surface thereof to the inner pad, the outer disc-shaped portion being slidably contactable at a sliding surface thereof to the outer pad, and the plurality of cooling fins being arranged between the inner disc-shaped portion and the outer disc-shaped portion so as to extend in a radial direction of the ventilated disc rotor in order to connect the inner disc-shaped portion to the outer disc-shaped portion so as to be integral, wherein the hat portion and the plurality of cooling fins are integrally made of a steel plate material, and the outer disc-shaped portion and the inner disc-shaped portion are formed by casting together with the plurality of cooling fins in such a way that the plurality of cooling fins integrally connects the inner disc-shaped portion to the outer disc-shaped portion.

2. The ventilated disc rotor according to claim 1, wherein each of the cooling fins is formed with a holding portion formed in an annular shape and circularly setting its center to a rotational center of the ventilated disc rotor, at a radially outer end portion of the cooling fins so as to connect the cooling fins to each other in a continuous manner, and the cooling fins are held at the holding portion when each of the cooling fins is processed by twisting or bending, or each of the cooling fins is formed with a holding portion formed in an arc shape relative to a rotational center of the ventilated disc rotor, at a radially outer end portion of the each of the cooling fins, and the cooling fins are held at the holding portion when each of the cooling fins is processed by twisting or bending.

3. The ventilated disc rotor according to claim 2, wherein the holding portion is removed from the radially outer end portion of the each of the cooling fins by cutting therefrom after the each of the cooling fins is processed by twisting or bending.

4. The ventilated disc rotor according to claim 2, wherein the outer disc-shaped portion is formed by casting together with a portion of the cooling fins at which the holding portion is formed.

5. The ventilated disc rotor according to claim 1, wherein a radially inner portion of at least one of the inner disc-shaped portion and the outer disc-shaped portion is directly joined to an annular end portion of the hat portion.

6. The ventilated disc rotor according to claim 1, wherein a bending portion is formed at at least one of first and second sides of the each of the cooling fins so as to bend in a rotational direction of the ventilated disc rotor, the inner disc-shaped portion is formed by casting together with the each of the cooling fins at the first surface thereof, and the outer disc-shaped portion is formed by casting together with the each of the cooling fins at the second surface thereof.

7. The ventilated disc rotor according to claim 1, wherein each of the cooling fins is formed with a formed portion by which the each of the cooling fins is restrained from being bending-deformed in the rotational direction of the ventilated disc rotor or an axial direction of the ventilated disc rotor.

8. The ventilated disc rotor according to claim 1, wherein each of the cooling fins is formed with at least one of through holes opening in a thickness direction of the each of the cooling fins.

9. The ventilated disc rotor according to claim 1, wherein each of the cooling fins is formed with an air guiding portion at the radially inner portion of the cooling fins in the radial direction of the ventilated disc rotor for guiding air to an air passage that is defined by each of the cooling fins, the inner disc-shaped portion, and the outer disc-shaped portion.

10. The ventilated disc rotor according to claim 1, wherein each of the cooling fins is formed with an axially projecting portion at one end surface of the cooling fin in the axial direction of the ventilated disc rotor so as to extend toward at least one of the sliding surface of the outer disc-shaped portion and the sliding surface of the inner disc-shaped portion in a predetermined length.

11. The ventilated disc rotor according to claim 1, wherein the hat portion is formed with plural notches at one end portion thereof where the cooling fins are formed so as to extend in the axial direction of the ventilated disc rotor for a predetermined length at a position between two adjacent cooling fins.

12. The ventilated disc rotor according to claim 3, wherein a radially inner portion of at least one of the inner disc-shaped portion and the outer disc-shaped portion is directly joined to an annular end portion of the hat portion.

13. The ventilated disc rotor according to claim 3, wherein a bending portion is formed at at least one of first and second sides of the each of the cooling fins so as to bend in a rotational direction of the ventilated disc rotor, the inner disc-shaped portion is formed by casting together with the each of the cooling fins at the first surface thereof, and the outer disc-shaped portion is formed by casting together with the each of the cooling fins at the second surface thereof.

14. The ventilated disc rotor according to claim 4, wherein a bending portion is formed at at least one of first and second sides of the each of the cooling fins so as to bend in a rotational direction of the ventilated disc rotor, the inner disc-shaped portion is formed by casting together with the each of the cooling fins at the first surface thereof, and the outer disc-shaped portion is formed by casting together with the each of the cooling fins at the second surface thereof.

15. The ventilated disc rotor according to claim 12, wherein the hat portion is formed with plural notches at one end portion thereof where the cooling fins are formed so as to extend in the axial direction of the ventilated disc rotor for a predetermined length at a position between two adjacent cooling fins.

16. The ventilated disc rotor according to claim 5, wherein a bending portion is formed at at least one of first and second sides of the each of the cooling fins so as to bend in a rotational direction of the ventilated disc rotor, the inner disc-shaped portion is formed by casting together with the each of the cooling fins at the first surface thereof, and the outer disc-shaped portion is formed by casting together with the each of the cooling fins at the second surface thereof.

17. The ventilated disc rotor according to claim 16, wherein the hat portion is formed with plural notches at one end portion thereof where the cooling fins are formed so as to extend in the axial direction of the ventilated disc rotor for a predetermined length at a position between two adjacent cooling fins.

18. The ventilated disc rotor according to claim 6, wherein the hat portion is formed with plural notches at one end portion thereof where the cooling fins are formed so as to extend in the axial direction of the ventilated disc rotor for a predetermined length at a position between two adjacent cooling fins.
